(19) United States
(12) Patent Application Publication
(10) Pub. No.: US 2013/0232792 A1
(43) Pub. Date: Sep. 12, 2013

(54) APPARATUS AND METHOD FOR SERVICING TURBOMACHINERY COMPONENTS IN-SITU

(71) Applicants: Diego Quinones, Rexford, NY (US); John Matthew Sassatelli, Valley Falls, NY (US); Francis Alexander Reed, Princetown, NY (US)

(72) Inventors: Diego Quinones, Rexford, NY (US); John Matthew Sassatelli, Valley Falls, NY (US); Francis Alexander Reed, Princetown, NY (US)

(73) Assignee: General Electric Company

(21) Appl. No.: 13/417,543

(22) Filed: Mar. 12, 2012

(51) Int. Cl. B23P 6/00; B24B 19/00

(52) U.S. Cl. 29/889.1; 451/177; 451/294

(57) ABSTRACT

An apparatus adapted for servicing a turbomachine component includes a tool delivery mechanism adapted for delivering a tool to a desired location in a turbomachine. A tool support is adapted to be secured onto the body of the turbomachine, and is also configured to support the tool delivery mechanism. A machining tool is attached to the tool delivery mechanism, and includes an axial slide clamp configured to clamp to the turbomachine component, a radial slide slidably connected to the axial slide clamp, a spring connected to the axial slide clamp and the radial slide, the spring providing axial tension, and a machining bit retained at least partially within the radial slide. The apparatus is adapted to service the component of the turbomachine in-situ.

### BACKGROUND OF THE INVENTION

The apparatus and method described herein relate generally to turbomachinery. More specifically, the apparatus and method relate to servicing or repairing turbomachinery components in-situ.

Turbine compressor blades can get damaged due to effects such as corrosion, rub cracks, pitting, and foreign objects. In the event of such damage, timely detection and repair of these blades are desirable to prevent tip liberation and subsequent compressor failure. The current practice for blade repair requires compressor case removal, which is inevitably time consuming and expensive. The removal of the compressor case for repair of compressor blades also creates undesirable outage time, thereby resulting in lost revenue for the machine owner/operator.

### BRIEF DESCRIPTION OF THE INVENTION

In an aspect of the present invention, an apparatus adapted for servicing a turbomachine component includes a tool delivery mechanism adapted for delivering a tool to a desired location in a turbomachine. A tool support is adapted to be secured onto the body of the turbomachine, and is also configured to support the tool delivery mechanism. A machining tool is attached to the tool delivery mechanism, and includes an axial slide clamp configured to clamp to the turbomachine component, a radial slide slidably connected to the axial slide clamp, a spring connected to the axial slide clamp and the radial slide, the spring providing axial tension, and a machining bit retained at least partially within the radial slide. The apparatus is adapted to service the component of the turbomachine in-situ.

In another aspect of the present invention, an apparatus is provided for servicing a turbomachine component. The apparatus includes a machining tool having an axial slide clamp configured to clamp to the turbomachine component, a radial slide slidably connected to the axial slide clamp, a spring connected to the axial slide clamp and the radial slide, the spring providing axial tension, and a machining bit retained at least partially within the radial slide. The apparatus is adapted to service the component of the turbomachine in-situ.

In yet another aspect of the present invention, a method is provided including the steps of adjusting an orientation of inlet guide vanes, adjusting a rotor/stator clocking, moving the tool delivery mechanism into a first desired position, rotating the tool delivery mechanism into a second desired position, attaching a machining tool to a component of the turbomachine, and manipulating a handle to move the machining tool repair the component.

### BRIEF DESCRIPTION OF THE DRAWINGS

FIG. 1 illustrates a partial, cut-away view of a turbomachine;

FIG. 2 illustrates a partial perspective view of a compressor showing the airfoils and vanes;

FIG. 3 illustrates examples of tip cropping performed on a compressor blade;

FIG. 4 illustrates a side view of the end effector of a machining tool that may be used to repair or machine a component, according to an aspect of the present invention;

FIG. 5 illustrates a simplified view of an axial slide clamp, according to an aspect of the present invention;

FIG. 6 illustrates a simplified view of an axial slide clamp, according to an aspect of the present invention;

FIG. 7 illustrates a perspective view of a tool delivery mechanism, according to an aspect of the present invention;

FIG. 8 illustrates a schematic view of the tool delivery mechanism and machining tool navigating through various rotor and stator stages in a compressor, according to an aspect of the present invention;

FIG. 9 illustrates an end view of the machining tool of FIG. 4 attached to or secured onto a component of a turbomachine, according to an aspect of the present invention;

FIG. 10 illustrates a perspective view of a tool delivery mechanism, according to an aspect of the present invention; and

FIG. 11 illustrates a method of repairing a turbomachine component, according to an aspect of the present invention.

### DETAILED DESCRIPTION OF THE INVENTION

One or more specific aspects/embodiments of the present invention will be described below. In an effort to provide a concise description of these aspects/embodiments, all features of an actual implementation may not be described in the specification. It should be appreciated that in the development of any such actual implementation, as in any engineering or design project, numerous implementation-specific decisions must be made to achieve the developers' specific goals, such as compliance with machine-related, system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “one aspect” or “an embodiment” or “an aspect” of the present invention are not intended to be interpreted as excluding the existence of additional embodiments or aspects that also incorporate the recited features.

A turbomachine is defined as a machine that transfers energy between a rotor and a fluid or vice-versa, including but not limited to a gas turbine, a steam turbine and a compressor. Turbomachinery is defined as one or more machines that transfer energy between a rotor and a fluid or vice-versa, including but not limited to gas turbines, steam turbines and compressors. The major challenge in the development of an in-situ blade or vane repair method and apparatus is to design a mechanism that can deliver the repair payloads to the target blade or vane inside the compressor, due to the stringent spatial constraints imposed by the tight workspace within the compressor flow path. The delivery mechanism should be capable of reaching both the leading edges and the trailing edges of the target vane, airfoil or blade (e.g., the second row of compressor rotor blades (R1) or vanes (S1)).

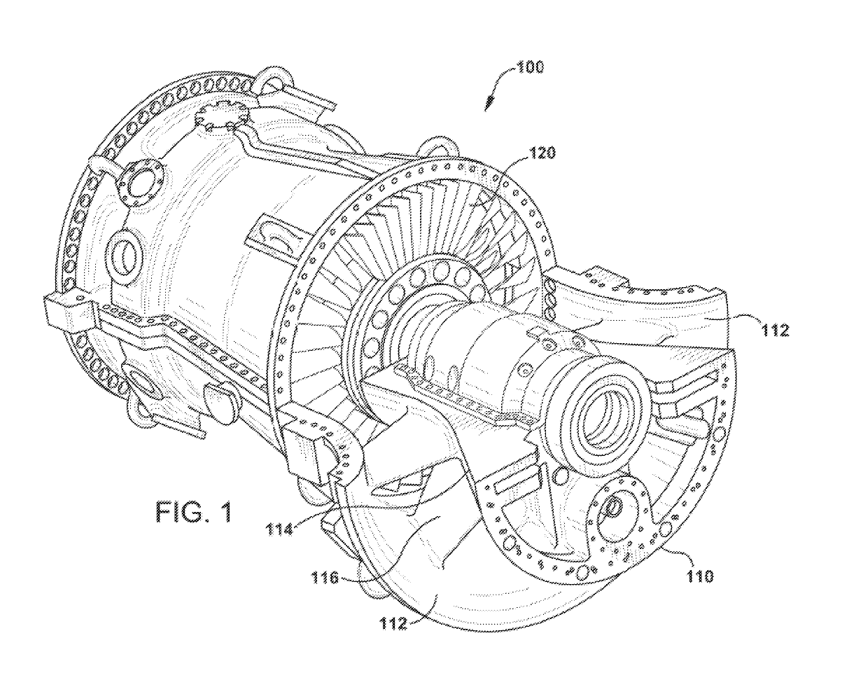

FIG. 1 illustrates a partial, cut-away view of a turbomachine 100, which may be a gas turbine compressor. However, it is to be understood that the present invention can be applied to any turbomachine, including but not limited to, gas turbines, steam turbines, compressors, etc. In turbomachine 100, half of the bell mouth 110 is omitted for clarity to show some of the vanes and blades inside. The first stage of stator vanes is called the inlet guide vanes (IGVs) 120. The bell mouth 110 includes an outer surface 112 and an inner surface 114, and incoming flow (e.g., air) passes between these two surfaces. Typically, a plurality of support members 116 are fastened or welded to the outer surface 112 and the inner surface 114 for support.

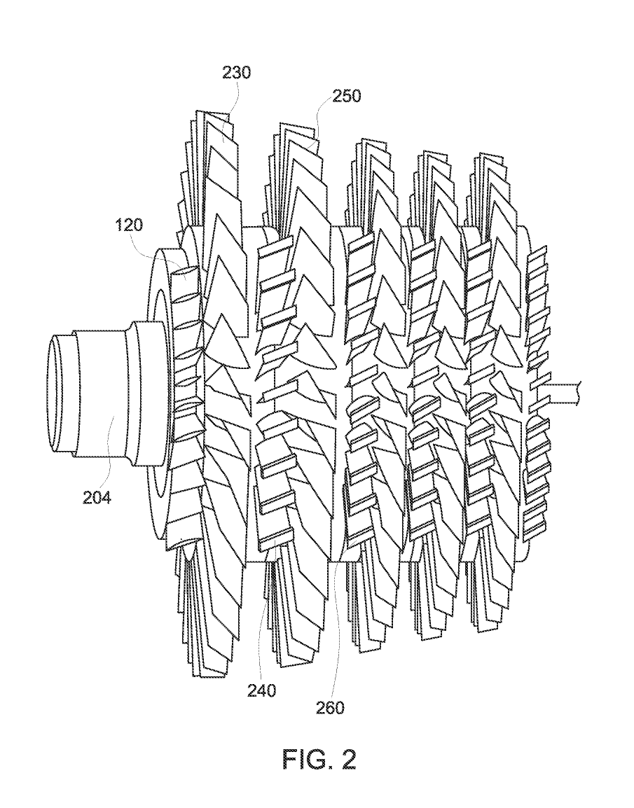

FIG. 2 illustrates a partial perspective view of compressor airfoils and vanes, with the casing omitted for clarity. The stator vanes are generally fixed, while the rotor airfoils/blades are connected to rotatable rotor 204. The inlet guide vanes 120 are generally fixed as well, but may pitch around a generally radial axis to vary the direction or amount of incoming flow. The inlet guide vanes 120 are followed by a first row of rotor airfoils 230. The airfoils can also be referred to as the R0 airfoils or blades, as they are part of the R0 stage. The stator vanes 240 are next, and can also be referred to as the S0 vanes, as they are part of the S0 stage. The next row of rotor airfoils/blades 250 can be referred to as the R1 airfoils or blades, as they are part of the R1 stage. The R1 airfoils are followed by the S1 stator vanes 260, as they are part of the S1 stage, and so on.

It would be desirable if a delivery mechanism could go through the bell mouth 110 and reach the target blade or vane, as well as deliver a desired tool set to perform the desired repair operation. As one example only, an R1 blade can experience various types of damage and this blade could be reached without requiring case removal, according to an aspect of the present invention.

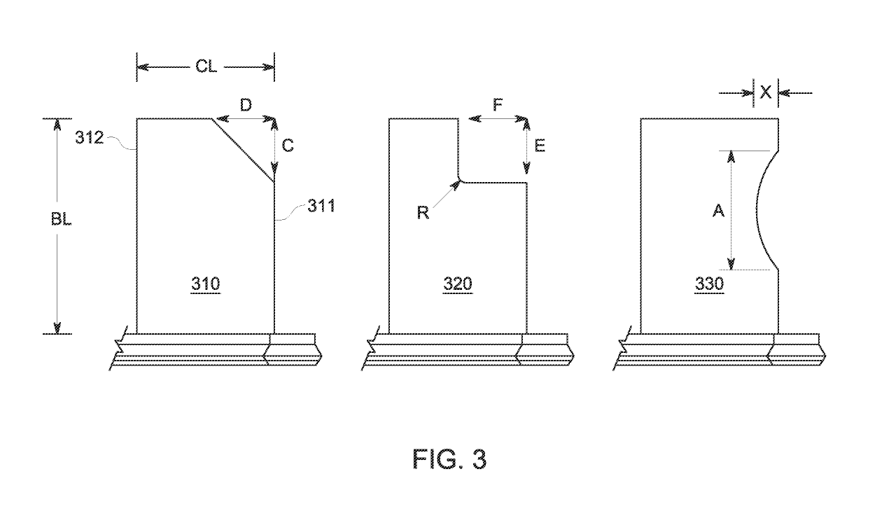

FIG. 3 illustrates a few examples of tip cropping repairs for an R1 blade, however, this type of repair could be applied to any blade or vane as desired in the specific application. The damage could be caused by corrosion, cracks, fatigue and/or pitting, as just a few examples. Therefore, according to the damages that typically occur to an R1 blade, three types of blending operations are identified and defined as shown in FIG. 3. Blade 310 illustrates a Type 1 blend, where a portion of the blade tip is removed. In this example, the maximum amount of D is equal to half of the chord length (CL), and the maximum amount of C is equal to one third of the blade length (BL). Blade 320 illustrates a Type 2 blend, where a maximum amount of E×F is equal to a predetermined amount and R is equal to a corner radius of about 0.25″. Blade 330 illustrates an edge blend, where A is greater than five times the distance of X (the chord depth of the damage). Accordingly, any specific amount and/or distance can be used as desired in the specific application, and the values given previously are merely exemplary. In addition, the Type 1, Type 2 and Type 3 blends may be located on the blade leading edge 311 and/or trailing edge 312. Other types of blends and repairs, including full tip crops, may also be completed by the present invention.

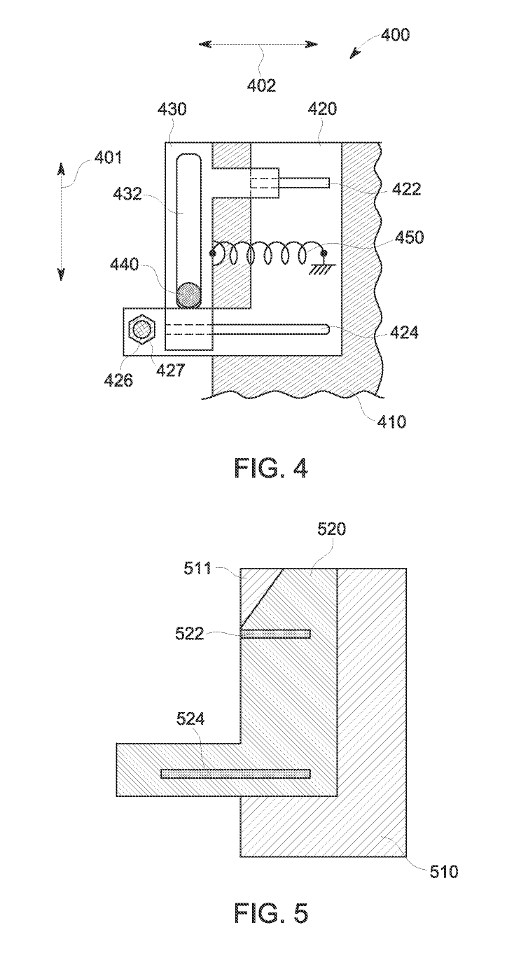

FIG. 4 illustrates a partial side view of a machining tool 400 (or apparatus), according to an aspect of the present invention. The machining tool 400 is configured to clamp onto a turbomachine component 410, such as a rotor blade, stator vane or rotor airfoil, and then machine a desired area of the component. The axial slide clamp 420 is disposed on both sides of component 410, and only one side of axial slide clamp is shown in FIG. 4. The axial slide clamp includes one or more generally axially extending slots 422 and 424. A tension applying device 426, such as a screw or clamp, is configured to clamp both sides of axial slide clamp 420 onto component 410.

A radial slide 430 is slidably connected to axial slide clamp 420, by one or more projections (not shown in FIG. 4) that extend into generally axially extending slots 422 and 424. The axially extending slots 422 are configured to permit axial movement of the radial slide 430. The projections may be cylindrical or rectangular in shape, or any other shape as desired in the specific application. The radial slide 430 also includes at least one generally radially extending slot 432 that is configured to permit radial movement of a machining bit 440. The radially extending slots 432 serve as stoppers or guides for the grinding bit 440, and the clamp 420 geometry (or shape) will change depending on the type of repair (e.g. square, rectangular, triangular or curvilinear) for repair as shown in the few non-limiting examples in FIG. 3. As shown in FIG. 4, the axial slide clamp 420 is configured for a Type 2 or rectangular shaped crop/repair. The radial direction is generally indicated by arrow 401 and the axial direction is generally indicated by arrow 402, and these directions generally translate to radial and axial directions of the turbomachine.

A spring 450 is connected to both the axial slide clamp 420 and the radial slide 430, and provides axial tension between both elements. The spring 450 pulls the machining bit 440 toward the surface of component 410 so that the bit 440 contacts the surface of component 410 during a machining operation. For example, during a machining operation when the machining bit 440 is a grinding bit, the spring 450 pulls radial slide 430 axially toward the component 410 as the grinding bit grinds away the desired portion of component 410. The tool bit 440 may also comprise a sander, polisher, marking device, pen, or any other suitable tool that may be desired in the specific application.

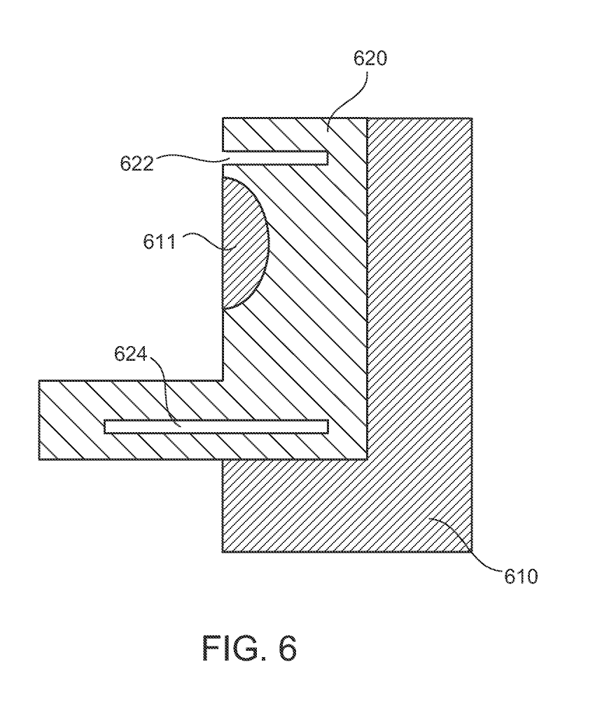

FIG. 5 illustrates an axial slide clamp 520 configured for a Type 1, or triangular, repair. The component 510 will have the triangular portion 511 removed after a repair or machining operation. The slots 522 and 524 are used by the radial slide (not shown in FIG. 5). FIG. 6 illustrates an axial slide clamp 620 configured for a Type 3, or curvilinear repair. The component 610 will have the semi-oval shaped portion 611 removed after a repair or machining operation. The slots 622 and 624 are used by the radial slide (not shown in FIG. 6).

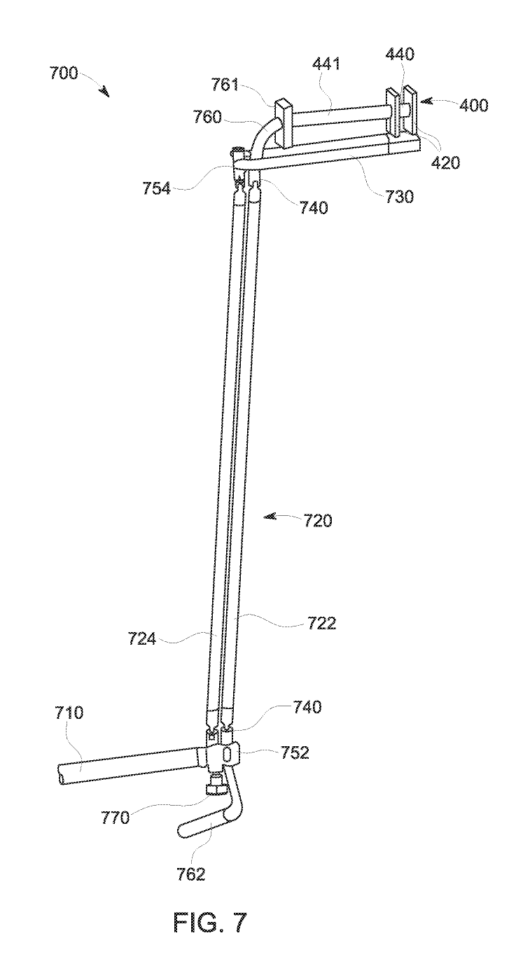

FIG. 7 illustrates a perspective view of a tool delivery mechanism 700 attached to the machining tool 400. The tool delivery mechanism 700 may be used to deliver a machining or repair tool (e.g., a grinder) into a turbine or compressor to reach the target blade or vane. As described earlier, a major challenge in the design of the tool delivery mechanism 700 is due to the stringent spatial constraints imposed by the tight workspace within the turbine or compressor flow path. In addition, there are an infinite number of possible clocking configurations of the first few rows of compressor blades/vanes, due to two uncertainties in clocking between different rows of blades/vanes. In particular, the clocking between the rotor and the stator can be arbitrary and the clocking between the 1^{st} stage and the 2^{nd} stage of rotor blades can be very different from one unit of a turbomachine to another. As the rotor/stator clocking is tunable (i.e., the rotor airfoils/blades can be turned relative to the stationary stator vanes), it can be strategically adjusted to facilitate the ingress/egress of the tool delivery mechanism 700, whereas the multiple rotor stage (e.g., R0/R1) clocking is fixed and therefore not controllable as it varies from one machine to another machine. The tool delivery mechanism 700 is thus designed to be capable of accomplishing all the three types of blends on airfoils, blades and vanes in various stages with various clocking settings or arrangements.

The tool delivery mechanism 700 includes a two-link mechanism that has been specifically designed to facilitate tool delivery. The tool delivery mechanism 700 includes a handle 710, a middle link 720 which includes two rods which may include a first rod 722 and a second rotary rod 724, and an end effector 730. A universal joint 740 is attached to each end of the first rod 722, and rotary (or second) rod 724. Thus four universal joints 740 may be employed in the tool delivery mechanism 700. The two rods 722, 724, with universal joints 740 at both ends are then assembled substantially parallel to each other and are attached to two end plates 752, 754. The handle 710 is attached to end plate 752, and the end effector 730 is attached to end plate 754. The terms “joint” or “joints” may be defined to include a universal joint and/or a ball joint, and universal joints and/or ball joints, respectively.

The machining tool includes two axial slide clamps 420 and a machining apparatus 441 driving the machining bit 440. In one example, the machining apparatus 441 is a motor that imparts rotational motion to bit 440. The motor could be an air (e.g., pneumatic) or electric powered motor, or any other suitable motor as desired in the specific application. The bit 440 could be any suitable abrasive media or material (e.g., a grinder, a sander, a polisher or also a marking device or pen). The machining apparatus 441 (and machining bit 440) are manipulated through a cable 760 that is attached at one end to a machining apparatus guiding rail 761, and at the opposing end to cable handle 762. An operator can push or pull the cable to move the machining apparatus 741, and this motion translates to movement of the machining bit 440. One or more springs 750 may be connected to the machining apparatus 441 to facilitate movement of the machining apparatus. This configuration allows the operator to control the speed of movement and the location of the machining bit 440 relative to the surface of component 410.

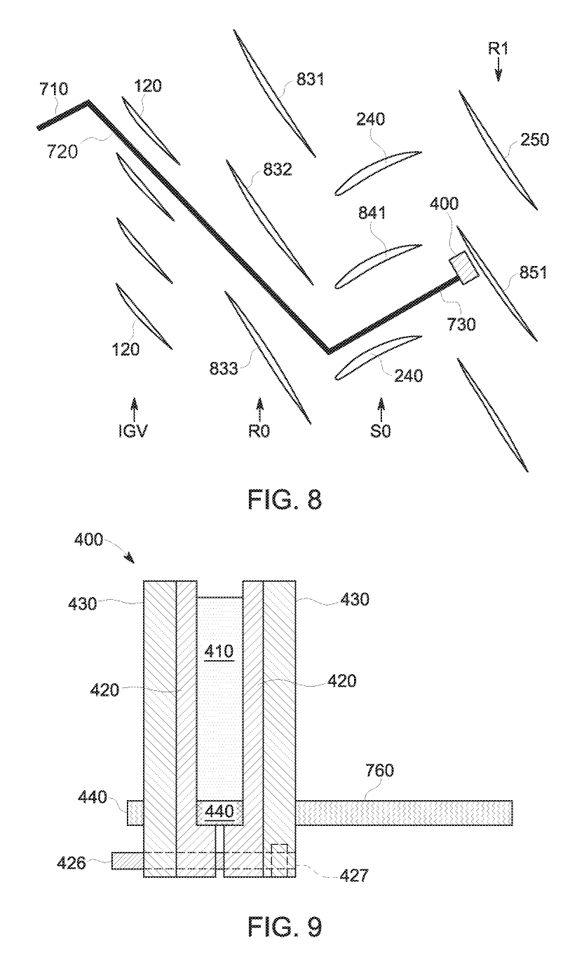

According to an aspect of the present invention, and referring to FIG. 8, a method is provided to insert the tool delivery mechanism 700 inside a turbomachine, e.g., a compressor, for repairing a part in the turbomachine. A first step can include adjusting the inlet guide vane 120 orientation, and this step may be followed or preceded by adjusting the rotor/stator clocking to facilitate the ingress/egress of the tool delivery mechanism 700. In order to insert the tool delivery mechanism 700 into the compressor 100 and perform the servicing/repair operation, the inlet guide vanes 120 may be oriented so that they are about parallel to the R0 blades 230. The relative clocking of rotor and stator may be adjusted so that the trailing edge, in this example, of the associated R0 blade 832 is in close proximity to the leading edge of an S0 vane 841. The associated R0 blade 832 is the blade that the target R1 blade 851 is circumferentially clocked in between the R0 blade 831 and the next R0 blade 833 in clockwise direction. After the associated R0 blade 832 is identified and its trailing edge is aligned with the leading edge of S0 vane 841, there will be two full openings at the S0 stage available for the insertion of the tool delivery mechanism 700.

During the insertion of the tool delivery mechanism 700, the 2-link mechanism is first oriented so that the end effector 730 is substantially radially aligned with the compressor and the middle link 720 is substantially parallel to the IGVs. To be more specific, the end effector 730 will be pointing substantially out of the page as in the view of FIG. 8. Then the tool delivery mechanism 800 can slide easily into the compressor until it reaches the desired position (e.g., the S0 or R1 stage). Then the tool delivery mechanism 700 can be rotated about 90 degrees and be placed in the configuration as shown in FIG. 8.

FIG. 9 illustrates a simplified end view of the machining tool clamped onto a component 410. The axial slide clamps 420 are clamped onto component 410 by the use of threaded rod 426 and fastener 427 (e.g., a nut or an internally threaded bore). The threaded rod may be rotated by actuation of knob 770, which in turn rotates the rotary rod 724 which is connected via suitable gearing and connectors to threaded rod 426. The radial slides 430 retain and guide bit 440, so that the bit may be moved up and down (as shown in FIG. 9) by the use of cable 760. The grinding portion of the bit 440 may be confined only to that portion of the bit 440 that will be in contact with the component 410. The sections of bit 440 that will be in contact with the clamps 420, which function as stoppers/guides providing the shape of the repair needed (e.g. rectangular or square for repair 320), will be flat or smooth to avoid grinding of clamps 420.

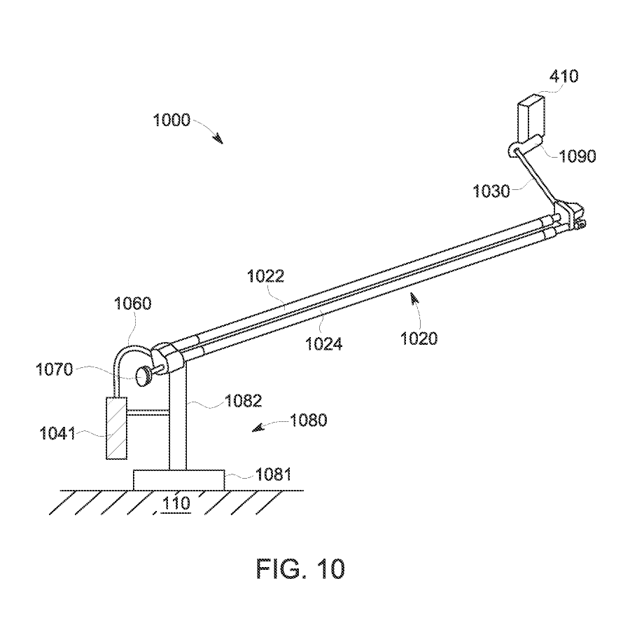

FIG. 10 illustrates a perspective view of another tool delivery mechanism and machining tool, according to an aspect of the present invention. The tool delivery mechanism 1000 includes middle link 1020 having two rods 1022 and 1024, end effector 1030 and knob 1070. The tool delivery mechanism is supported by tool support 1080 which has a base 1081 and support member 1082. The base 1081 may include magnetic devices or can be configured to be non-magnetic. The base is placed on a surface of the bell mouth 110. A motor 1041, which may be pneumatic or electrical, is connected to a shaft or conduit 1060. This shaft or conduit 1060 extends to a machining tool 1090 located at the distal end of the tool delivery mechanism. The machining tool (which may be similar to machining tool 400) is clamped to or placed near a component 410.

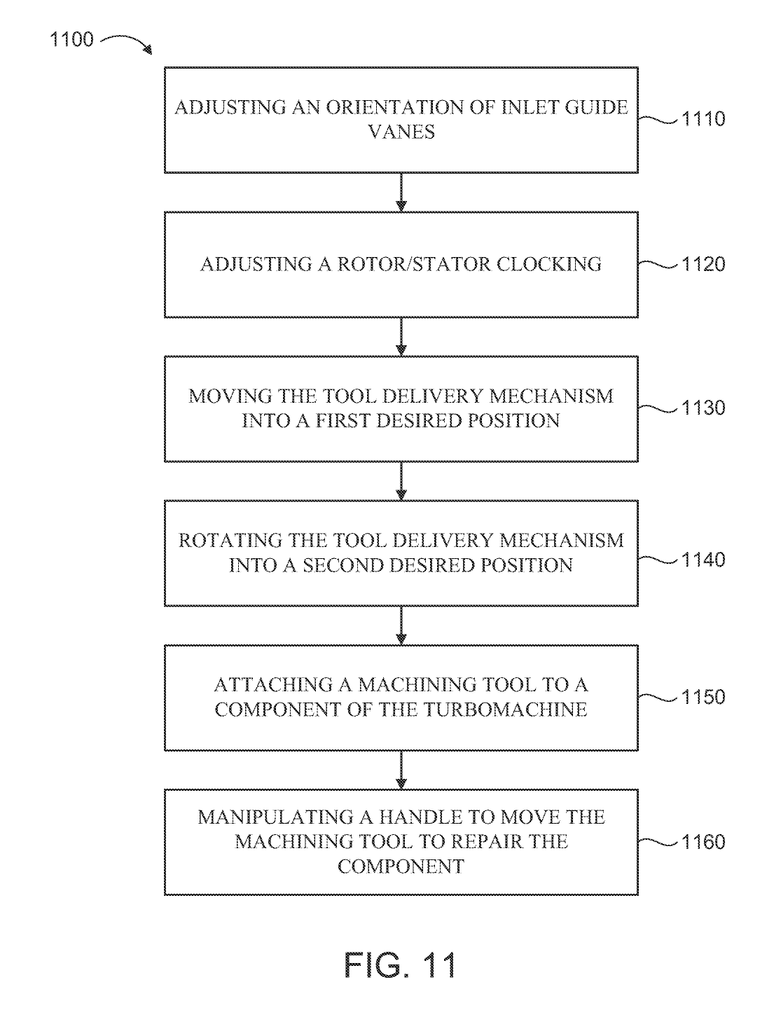

FIG. 11 illustrates a method 1100 of repairing a turbomachine component according to an aspect of the present invention. The method 1100 includes a step 1110 of adjusting an orientation of inlet guide vanes, a step 1120 of adjusting a rotor/stator clocking, a step 1130 of moving the tool delivery mechanism into a first desired position, a step 1140 of rotating the tool delivery mechanism into a second desired position, a step 1150 of attaching a machining tool to a component of the turbomachine, and a step 1160 of manipulating a handle to move the end effector to at least one of: inspect, mark and repair a component in a turbomachine. The above method can also include orienting a middle link of the tool delivery mechanism so that the middle link is substantially parallel to inlet guide vanes, and subsequently moving the end effector into position near at least one of: an S0 vane, an S1 vane, an R0 blade and an R1 blade. Another step may include monitoring the insertion of the machining tool as well as monitoring the repair process, and this may be accomplished by the use of a borescope video imaging device (not shown). The method can also include the step of performing at least one of a Type 1, Type 2 and a Type 3 in-situ repair on at least one of an S0 vane, an S1 vane, an R0 blade and an R1 blade.

One important feature for the mechanical design of the tool delivery mechanism 700 is that the whole system should have adequate rigidity to withstand the varying forces produced during the repair or grinding operations. For example, experience has shown that grinding forces may be up to about 30 lbf or more in all directions and within a wide spectrum (0˜about 500 Hz and up). Insufficient rigidity of the system will result in chattering during grinding operation, reducing machining accuracy and maneuverability. The positioning uncertainty at the end of the grinding head should be less than a predetermined distance at a nominal 30 lbf machining load to assure machining accuracy. In the ideal case, the location of the grinder head should be primarily determined by the orientation of the handle 510 and the cable 760/handle 762. However, due to the flexibility of each mechanical component in the tool delivery mechanism 700, and the backlashes in the joints, including both the universal joints 740 and the prismatic joint of the end effector 730, the tool head location may vary under machining loads even though the operator does not intend to vary it. Therefore component stiffness and joint backlashes are important considerations in designing and implementing the tool delivery mechanism 500.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An apparatus adapted for servicing a turbomachine component comprising:
a tool delivery mechanism adapted for delivering a tool to a desired location in a turbomachine;
a tool support adapted to be secured onto the body of the turbomachine, the tool support configured to support the tool delivery mechanism;
a machining tool attached to the tool delivery mechanism, the machining tool comprising:
an axial slide clamp configured to clamp to the turbomachine component;
a radial slide slidably connected to the axial slide clamp;
a spring connected to the axial slide clamp and the radial slide, the spring providing axial tension;
a machining bit retained at least partially within the radial slide; and
wherein, the apparatus is adapted to service the component of the turbomachine in-situ.

2. The apparatus of claim 1, wherein the axial slide clamp further comprises:
at least one generally axially extending slot, the at least one axially extending slot configured to permit axial movement of the radial slide.

3. The apparatus of claim 2, wherein the radial slide further comprises:
a generally radially extending slot, the radially extending slot configured to permit radial movement of the machining bit.

4. The apparatus of claim 1, the apparatus in combination with the turbomachine, wherein the turbomachine is at least one of: a gas turbine, a steam turbine, and a compressor.

5. The apparatus of claim 4, wherein the component is at least one of:
a rotor airfoil, a rotor blade, and a stator vane.

6. The apparatus of claim 5, wherein the turbomachine is the compressor and the component is the rotor airfoil or the rotor blade, and wherein the component is part of an R0 or R1 stage of the compressor.

7. The apparatus of claim 5, wherein the turbomachine is the compressor and the component is the stator vane, and wherein the component is part of an S0 or S1 stage of the compressor.

8. The apparatus of claim 1, the tool delivery mechanism further comprising:
a handle attached to a first end plate;
a middle link attached to the first end plate by a first plurality of universal joints; and
an end effector attached to a second end plate, where the second end plate is attached to the middle link by a second plurality of universal joints.

9. The apparatus of claim 8, the middle link further comprising:
a first rod, a second rotary rod.

10. The apparatus of claim 8, further comprising:
a cable attached at one end to a cable handle and at the other end to a guiding rail;
wherein, movement of the cable translates to movement of the machining tool.

11. The apparatus of claim 10, wherein the machining tool further comprises:
a motor; and
at least one of a grinder, a sander, a polisher, a marking device, or a pen.

12. The apparatus of claim 11, wherein the motor is at least one of an electric motor or a pneumatic motor.

13. The apparatus of claim 12, wherein the motor is connected to one or more springs, the one or more springs also attached to the end effector.

14. An apparatus adapted for servicing a turbomachine component comprising:
a machining tool comprising:
an axial slide clamp configured to clamp to the turbomachine component;
a radial slide slidably connected to the axial slide clamp;
a spring connected to the axial slide clamp and the radial slide, the spring providing axial tension;
a machining bit retained at least partially within the radial slide; and
wherein, the apparatus is adapted to service the component of the turbomachine in-situ.

15. The apparatus of claim 14, wherein the axial slide clamp further comprises:
at least one generally axially extending slot, the at least one axially extending slot configured to permit axial movement of the radial slide.

16. The apparatus of claim 15, wherein the radial slide further comprises:
at least one generally radially extending slot, the at least one radially extending slot configured to permit radial movement of the machining bit.

17. The apparatus of claim 16, wherein the machining tool further comprises:
a motor; and
at least one of a grinder, a sander, a polisher, a marking device, or a pen.

18. The apparatus of claim 17, further comprising:
a cable attached at one end to a cable handle and at the other end to a guiding rail;
wherein, movement of the cable translates to movement of the machining tool.

19. A method of repairing a turbomachine component comprising:
adjusting an orientation of inlet guide vanes;
adjusting a rotor/stator clocking;
moving a tool delivery mechanism into a first desired position;
rotating the tool delivery mechanism into a second desired position;
attaching a machining tool to the turbomachine component;
manipulating a handle to move the machining tool to repair the turbomachine component.

20. The method of claim 19, further comprising:
performing at least one of a Type 1, Type 2 and a Type 3 repair on at least one of:
an S0 vane, an S1 vane, an R0 blade and an R1 blade.
